(19) United States
(12) Patent Application Publication
(10) Pub. No.: US 2023/0099257 A1
(43) Pub. Date: Mar. 30, 2023

(54) DESIGN METHOD FOR DISTRIBUTED HYDROLOGICAL CYCLE MODEL BASED ON MULTI-SOURCE COMPLEMENTARY WATER SUPPLY MODE

(71) Applicant: Changjiang River Scientific Research Institute of Changjiang Water Resources Commission, Wuhan City (CN)

(72) Inventors: Mingzhi YANG, Wuhan City (CN); Jijun XU, Wuhan City (CN); Lianhai SANG, Wuhan City (CN); Qiang LIU, Wuhan City (CN); Suge ZHU, Wuhan City (CN); Jianfeng LIU, Wuhan City (CN); Quan SONG, Wuhan City (CN); Dacong YIN, Wuhan City (CN); Sinuo LI, Wuhan City (CN); Zhong CAO, Wuhan City (CN)

(21) Appl. No.: 17/867,221

(22) Filed: Jul. 18, 2022

(30) Foreign Application Priority Data
Aug. 18, 2021 (CN) 202110946366.8

(51) Int. Cl. G01V 99/00

(52) U.S. Cl. CPC G01V 99/005; G01V 2210/66

(57) ABSTRACT

The present disclosure provides a design method for a distributed hydrological cycle model based on a multi-source complementary water supply mode, the method including the following steps: S1, nested hydrological response unit (HRU) division; S2, HRU attribute design; S3, design of a multi-source complementary water supply module; and S4, improvement on a SWAT model. Based on the Soil and Water Assessment Tool (SWAT) model, the present disclosure develops a distributed natural-artificial hydrological dynamic reciprocal simulation model. The model is endowed with the functions of simulating dynamic reciprocation of natural water cycle and artificial water cycle, and integration of development, utilization and regulation of water resources, thereby simulating a natural-artificial hydrological cycle based on modes of urban multi-source water supply and multi-source irrigation water supply.

### CROSS REFERENCE TO RELATED APPLICATION

This patent application claims the benefit and priority of Chinese Patent Application No. 202110946366.8, filed on Aug. 18, 2021, the disclosure of which is incorporated by reference herein in its entirety as part of the present application.

### TECHNICAL FIELD

The present disclosure relates to the technical field of hydrological model design, and in particular to a design method for a distributed hydrological cycle model based on a multi-source complementary water supply mode.

### BACKGROUND ART

With the development of human productivity and technological progress, human activities are exerting an increasingly significant effect on the hydrological cycle, and the hydrological cycle of basins exhibits complicated natural-artificial compound characteristics during evolution. Most of the traditional hydrological models are developed based on the mechanism of runoff yield and concentration, which generally focuses on the surface runoff simulation, but poorly considers the development and utilization of water resources. Moreover, such models take no account of artificial water withdrawal and regulation decisions, making it difficult to meet the requirements for fine simulation in the basins affected by high intensity human activities. Many experts and scholars in hydrology and hydrology-related disciplines have begun to seek new breakthroughs in traditional hydrological model frameworks, in a bid to study the evolution rule of the hydrological cycle under human disturbance. Against this background, a distributed natural-artificial hydrological cycle model comes into being.

Coupling a di stributed hydrological model with a lumped water resources allocation model is one of the most common methods to construct a natural-artificial distributed hydrological cycle model. With the goal of accurately simulating a hydrological cycle, the distributed hydrological model can supplement the process of hydrological cycle that cannot be achieved by the water resources allocation model, and provide the real-time water resources boundary conditions as needed; the water resources allocation model can deal with the process of development and utilization of water resources under human control, and provide the data about water collection, water use, water consumption and water drainage, thus effectively improving the simulation accuracy of the model. The combination of the two allows them to learn from each other, and fully leverage their respective strengths, thereby achieving the accurate simulation of natural-artificial hydrological cycle. For example, in Literature 1 (Zhao Yong. Study on Rational Allocation of Generalized Water Resources [D]. China Institute of Water Resources and Hydropower Research, 2006.), Plain Distributed Water Cycle Model (PDWCM) is coupled with Generalized Water Resources Rational Allocation Model (GWRAM), and decomposition and aggregation are adopted for information interaction, which realizes simulation throughout the process of natural-artificial hydrological cycle; in Literature 2 (Zhang Honggang, Xiong Ying, Bing Jianping, Li Mingxin. Study on Coupling of Hydrological Model NAM and Water Resources Allocation Model [J]. Yangtze River, 2008(17): 15-17.), with the coupling of a hydrological model NAM and a water resources allocation model, the mechanism of how water resources in Hanjiang River Basin response to the influence of high-intensity human activities is studied; in Literature 3 (Zhang Shouping. Study on Joint Allocation of Water Volume and Water Quality Based on River Basin Hydrological Cycle and Associated Process Thereof [D]. China Institute of Water Resources and Hydropower Research, 2015.), a lumped water resources allocation model is used to simulate the artificial process of “water withdrawal, water use, water consumption, water drainage”, the partitioned data of water resources allocation based on third-grade regions and prefecture-level cities are transferred to the calculation units obtained through division by the elevation zones of sub-basins, which achieves coupling with the distributed hydrological cycle model WEP-L, and simulates the natural-artificial hydrological cycle and associated process for the Wei River Basin.

However, most of these models are constructed in the way of loosely coupling distributed hydrological models and lumped water resources allocation models, that is, the model coupling is realized by the one-way transmission of common parameters or output files, which ignores the dynamic reciprocation between the natural hydrological cycle and the social hydrological cycle, fails to give comprehensive reflection on the mutual influence between the water use process in human activities and the natural hydrological process, thus being disadvantageous to the fine simulation and regulation of water resources.

### SUMMARY

In view of deficiencies of a current distributed natural-artificial hydrological cycle model in terms of simulating coupling between natural-artificial hydrological cycles, and in developing, utilizing, and regulating water resources, the present disclosure, supported by a SWAT model, develops a distributed model for simulating dynamic reciprocation between the natural-artificial hydrological cycles based on the theory of natural-artificial hydrological cycles. By adding a multi-source complementary water supply module, the SWAT model is endowed with the functions of simulating dynamic reciprocation between the natural-artificial hydrological cycles, and developing, utilizing, and regulating water resources. In the running of the model, the dynamic reciprocal relationship between the natural hydrological cycle and the artificial hydrological cycle is maintained all the time, which not only reflects the influence of the hydrological cycle on the artificial water withdrawal, but also reflects the real-time intervention of economic and social activities in the hydrological cycle.

The present disclosure is implemented by the following technical solutions:

A design method for a distributed hydrological cycle model based on a multi-source complementary water supply mode, including the following steps:
Step S1: nested HRU division: conducting HRU division by adopting a nested slope discretization method based on attributes of “basin, water resources region, administrative region, irrigation area, land use, soil, slope”, HRUs obtained after division having corresponding attributes;
Step S2: HRU attribute design: constructing an HRU attribute recognition module, where the HRU attribute recognition module is configured to recognize attributes of an HRU;
Step S3: designing a multi-source complementary water supply module, where the multi-source complementary water supply module is configured to invoke the HRU attribute recognition module to recognize the attributes of each HRU, determining a land use type, a corresponding water source and a water supply priority of the water source according to the recognized attributes, and invoking, by the water supply priority of the water source, a corresponding water source module to conduct water withdrawal; and
Step S4: Soil and Water Assessment Tool (SWAT) model improvement: connecting the multi-source complementary water supply module with modified modules in a SWAT model to realize real-time data exchange, where the HRU daily allocates and regulates water resources according to input information about water demand, types of water sources, rules of water supply priority, and water conservancy projects, and information about natural hydrological conditions which is provided by the SWAT model, and outputs and transfers information about an artificial water cycle regarding daily “water supply, water use, water consumption, water drainage” to the SWAT model; where the SWAT model simulates and depicts the process of a natural hydrological cycle according to the information about the artificial hydrological cycle, simulates the influence of hydrological changes on the development and utilization of water resources in real time, and simulates the influence of artificial water utilization on the water resource and water supply at the next stage, which provides real-time information about natural hydrological boundary conditions for the artificial hydrological cycle, and thus achieves simulation on dynamic reciprocation between “natural-artificial” hydrological cycles.

Further, step S1 includes:
(1) extracting a river network of a basin from DEM information using ArcGIS to conduct division to obtain natural sub-basins;
(2) superimposing land use information, soil type information and slope information on the natural sub-basins to conduct division to obtain natural HRUs;
(3) setting boundaries of an administrative region and a water resources region for the natural HRU to further divide the natural HRUs; and
(4) superimposing irrigation areas with the natural HRUs according to the distribution of the irrigation areas to finally complete HRU division. Each HRU has a sub-basin attribute, a water resources region attribute, an administrative region attribute, an irrigation area attribute, a land use type attribute and a soil type attribute.

Further, step S2 includes:
(1) constructing an HRU attribute recognition module, which specifically includes constructing the HRU attribute recognition module which is configured to read specified HRU attributes, where the specified HRU attributes include a sub-basin attribute, a water resources region attribute, an administrative region attribute, and an irrigation area attribute; and
(2) invoking the HRU attribute recognition module, which specifically includes putting the constructed HRU attribute recognition module in a main module in the SWAT model to facilitate invocation of the HRU attribute recognition module.

Further, step S3 includes:
(1) designing a water source code information file:
   where the water source code information file is configured to read designated water source information, six types of water sources are set and include transferred water, reservoir water, urban river water, shallow groundwater, deep groundwater and pit-pond water, and the water source code information file is read by program instructions;
(2) designing a water supply priority information file:
   where the water supply priority information file is configured to read information about water supply priority, and specify a water supply priority of a water source, and is read by program instructions;
(3) designing a water withdrawal control information file:
   where the water withdrawal control information file is configured to read information about surface water supply control volume and groundwater exploitation control volume, and recognize an annual surface water supply control volume and an annual groundwater exploitation control volume of an administrative region to which the HRU belongs for the subsequent calculation of water withdrawal volume of water sources; and
(4) designing calculation for multi-source complementary water supply, where a calculation process is as follows:
   1) recognizing types of HRUs, which specifically includes
      recognizing the land use type of the HRU, where if it is residential and industrial land, a program enters a calculation process for urban rural water supply; if it is irrigation land, the program enters a calculation process for irrigation water; and if it is other land use type, the program ends;
   2) recognizing the water source and priority thereof, which specifically includes
      invoking a corresponding water source module by recognizing a water withdrawal source identification code of the HRU, recognizing the number, type and water withdrawal sequence of water sources of each HRU by reading the water source code information file and water supply priority information file, and invoking each water source module in turn according to the water withdrawal source identification code; and
   3) calculating multi-source complementary water supply, which specifically includes
      seeking water sources and conducting water withdrawal from each water source according to a water supply sequence of the HRU until the HRU’s daily demand for domestic water, industrial water, and agricultural irrigation water is satisfied, or until the last water source finishes water supply.

Further, the calculation for multi-source complementary water supply includes the following steps:
1) specifying a daily water demand WD set by a target HRU;
2) recognizing the number k, water source codes and water supply priority of water sources of the target HRU, where k≤30;
3) invoking the water source modules in sequence to calculate a water withdrawal volume of a water source, where the water source modules include a rchuse module, a res module and a watuse module, the water withdrawal volume of the water source depends on a daily water demand of the HRU and an available water supply of the water source, while the available water supply depends on an accessible water volume of the water source, the water supply capacity of a water withdrawal project (such as water diversion channels, water supply pipelines, and power-driven wells) and the water withdrawal control volume, where the calculation formulas are as follows:
$$W S {P}_{i j} = min \left(W {D}_{i} - {\sum }_{k = 1}^{j - 1} W S {P}_{k} , W s {c}_{i j}\right)$$
$$W s {c}_{i j} = min \left(W {A}_{i j} , W {F}_{i} , W M {X}_{i j} - {\sum }_{k = 1}^{j - 1} W S {P}_{k}\right)$$
$$W M {X}_{i j} = \left\{\begin{matrix}min \left(W U M - {\sum }_{m = 1}^{i - 1} {\sum }_{k = 1}^{j} W S {P}_{k} , W S M - {\sum }_{m = 1}^{i - 1} {\sum }_{k = 1}^{j} W S {P}_{k}\right) \\ min \left(W U M - {\sum }_{m = 1}^{i - 1} {\sum }_{k = 1}^{j} W S {P}_{k} , W G M - {\sum }_{m = 1}^{i - 1} {\sum }_{k = 1}^{j} W S {P}_{k}\right)\end{matrix}\right)$$
where, i denotes a sequence number of an HRU; j denotes a water supply priority number of a water source; WSP denotes an actual daily water withdrawal volume (m³) of a water source; WD indicates a daily water demand (m³) of an HRU; Wsc indicates a daily available water supply (m³) of a water source; WF indicates the water supply capacity (m³) of a water withdrawal project; WA indicates a daily accessible water volume of a water source (m³); WMX denotes an annual water withdrawal control volume (m³), and WUM denotes an annual water consumption control volume (m³); WSM denotes an annual surface water withdrawal control volume (m³); and WGM denotes an annual groundwater exploitation control volume (m³); where
4) for a water source with a water supply priority of 1, priority is given to water withdrawal from the water source; if the available water supply of the water source is Wsc₁>WD, then the water supply of the water source is WSP₁=WD, a water supply program ends, and the total water supply of the water source of the HRU is WSP= WSP₁; otherwise, WSP₁=Wsc₁, and the water demand of the HRU changes to Wf =WD-Wsc₁, and the program will continue to seek the next grade of water source;
5) for a water source with a water supply priority ofj (j=2, ... , k-1; k≤30), priority is given to water withdrawal from the water source. If the daily available water supply of the water source is Wscⱼ>Wf, then the water supply of the water source is WSPⱼ=Wf, the program ends, and the total water supply of the water source the HRU is SP=WSP+WSPⱼ; otherwise, WSPⱼ=Wscⱼ, the water demand of the HRU changes to Wf=Wf-Wscⱼ, and the program will continue to seek the next grade of water source; and
6) for a water source with a water supply priority of k (k≤30), if the daily available water supply of the water source is Wscₖ>Wf, then the water supply of the water source is WSPₖ=Wf, the program ends, and the total water supply of the HRU is WSP=∑WSPᵢ; otherwise, WSPₖ=Wscₖ, the water demand of the HRU changes to Wf=Wf-Wscₖ, and the program ends.

Further, modification for the SWAT model in step S4 specifically includes:
(1) shielding modules, which includes
   shielding the water source modules, namely the rchuse module, the res module, the watuse module, the irr_rch module, the irr res module and the irrsub module, and forgoing adopting a single water source withdrawal mode; and putting the foregoing modules into the multi-source complementary water supply module for invoking;
(2) modifying the rchuse module and the res module, which includes
   adding codes separately, and replacing parameters waterrch and wuresn in the rchuse module and the res module with parameter WSPᵢ (i=1,2) respectively to achieve connection of the multi-source complementary water supply module Multi_sc with the rchuse module and the res module as well as invoking;
(3) modifying the watuse module, which includes
1) modifying programs to add functions of transferred water withdrawal and transferred water volume restriction so as to control water supply within a total transferred water limit given that the module does not have the function of transferred water supply, where a calculation formula is expressed as follows:
$${\sum }_{i} {\sum }_{j} \text{waterout} ( i , j ) \leq M X 5$$
where waterout (ij) denotes transferred water consumption (m³) of the jth HRU on the ith day; and WX5 denotes total transferred water limit (m³);
2) adding codes in the watuse module, and replacing parameters watershal, waterdeep, waterout, and waterpnd in the watuse module with parameter WSPᵢ (i=3,4,5,6), respectively to achieve connection of the multi-source complementary water supply module Multi_sc with the watuse module as well as invoking;
(4) adding a function of simulating water delivery of a pipe network, which includes
adding a calculation program of the following formula in the rchuse module, the res module and the watuse module to resolve loss in urban water supply caused when water “escapes, overflows, drips or leaks” due to aging or breakage of a pipe network:
$$W S P = W S P ⋅ \left(1 - p i p\right)$$
where, pip denotes a leakage rate of water supply pipe network;
(5) modifying the irrsub module, which includes
in terms of the absence of a pit-pond irrigation function in the module, adding the pit-pond irrigation function; completing a transferred water irrigation function; and imposing water supply restriction to control an irrigation water withdrawal within the total transferred water limit:
$${\sum }_{i} {\sum }_{j} w i r r o u t \left(i , j\right) \leq M X 5$$
$${\sum }_{i} {\sum }_{j} w i r r p n t \left(i , j\right) \leq M X 6$$
where wirrout (i,j) denotes transferred water irrigation consumption (m³) of the jth HRU on the ith day; WX5 denotes total transferred water limit (m³), and wirrpnt (i,j) denotes pit-pond irrigation consumption (m³) of the jth HRU on the ith day; and WX6 denotes pit-pond available water supply (m³);
(6) adding a function of simulating an irrigation channel, which includes
1) given that the SWAT model does not consider the influence of water delivery loss of an irrigation channel on a hydrological cycle, and irrigation-related leakage is deemed as system loss, modifying source codes of the irr_rch module, the irr_res module, and the irrsub module, and adding simulation on a channel system delivery process including channel water loss and channel recession, where the channel water loss includes two parts of channel water evaporation loss and channel leakage loss, and the main calculation formulas are as follows:
$$E {T}_{c a n} = I R {R}_{c a n} ⋅ \left(1 - φ\right) ⋅ α$$
$$L {s}_{c a n} = I R {R}_{c a n} ⋅ \left(1 - φ\right) ⋅ β$$
$$S u r {p}_{c a n} = I R {R}_{c a n} ⋅ \left(1 - φ\right) ⋅ \left(1 - α - β\right)$$
where, ET_{can} denotes a channel system evaporation loss (mm); IRR_{can} denotes an irrigation water volume (mm) entering a channel; L_{Scan} denotes a channel system leakage loss (mm); Surp_{can} denotes a channel system recession volume (mm); φ denotes an effective utilization coefficient of channel system water; a denotes a channel system evaporation coefficient; and β denotes a channel system leakage coefficient;
2) driving water from leakage loss to enter upper soil as replenished soil water and participate in the soil moisture cycle, and adding a calculation program for leakage loss by modifying relevant codes of a percmain module, where a calculation formula is as follows:
$$W s {l}_{y r i , t} = W s {l}_{y r i , t - 1} + {inf}_{p e p} + {inf}_{i r r} + {inf}_{w e t} + L {s}_{c a n}$$
where,
$$W s {l}_{y r 1 , t + 1}$$
denotes soil water content (mm) of a first layer of soil on the t-th day;
$$W s {l}_{y r 1 , t}$$
denotes soil water content (mm) of a first layer of soil on the (t-1)th day; inf_{pcp} denotes precipitation infiltration capacity (mm); infᵢᵣᵣ denotes irrigation infiltration capacity (mm); and inf_{wet} denotes lake and reservoir wetland infiltration capacity (mm);
(7) modifying codes of the gwmod module, which includes
driving water loss from leakage of a water supply pipe network to enter a shallow aquifer as replenished groundwater, and modifying groundwater recharge codes in a gwmod module to achieve simulation on water leakage of a pipe network, where a calculation formula is as follows:
$$\begin{matrix}r {h}_{t} = \left(1 - exp \left(- 1 / G W \_ D E L A Y\right)\right) ⋅ \left(p r c + W S P ⋅ p i p / A r e a\right) \\ + exp \left(- 1 / G W \_ D E L A Y\right) ⋅ r {h}_{t - 1}\end{matrix}$$
where,
$$r {h}_{t}$$
denotes groundwater recharge capacity (mm) on the t-th day;
$$r {h}_{t - 1}$$
denotes groundwater recharge capacity (mm) on the (t-1)th day; prc denotes soil water leakage (mm) of recharged groundwater; GW_DELAY denotes groundwater recharge delay coefficient (mm); and Area denotes the area (m²) of an HRU;
(8) modifying the subbasin module, which includes
   adding the multi-source complementary water supply module in a subbasin module to facilitate revoking during the running of the SWAT model, and conducting in-year dynamic complementary water supply operation on water sources by reading specified type, number, water source codes, water withdrawal volume, and water withdrawal time of water sources to achieve multi-source combined water supply simulation during the running of the SWAT model;
(9) modifying the surface module, where
channel system recession refers to irrigation water discharged and overdrawn from the channel, which directly enters the river channel and participates in the calculation of flow concentration of river channel, by modifying the relevant codes of the surface module, the earth surface runoff is superimposed, and a calculation formula is as follows:
$$s u r {f}_{t} = s u r {f}_{0} + S u r {p}_{c a n}$$
where, surfₜ denotes runoff (mm) after channel recession; and surf₀ denotes runoff (mm) before channel recession;
(10) modifying the point source module, where
after urban domestic and industrial sewage is produced, it is directly discharged into the river through the drainage pipe network system, or transported to the sewage disposal plant for disposal, some of the up-to-standard sewage obtained after disposal is directly discharged into the river, and some of the up-to-standard reclaimed water obtained after advanced disposal is reused for greening, domestic miscellaneous use and production; the SWAT model conducts simulation using a point source module, where the point source module includes a recday module and a recmon module, where relevant codes are modified in the recday module and the recmon module, a pollution discharge parameter WDR is used to replace parameters floday and flomon, respectively, and the calculation formulas are as follows:
$$W P = W S P ⋅ \left(1 - r\right)$$
$$W D P = W P ⋅ \left(1 - v\right) + W P ⋅ v ⋅ \left(1 - r e\right)$$
where WDR denotes urban sewage output (m³); WP denotes sewage discharge (m³); r denotes a water consumption rate; v denotes a sewage disposal rate of a sewage disposal plant; and re denotes a reclaimed water utilization rate; and
(11) modifying the main module, which includes
   putting the constructed readattr module in the main module in the SWAT model to facilitate invocation of the readattr module.

Compared with the prior art, the present disclosure has the following beneficial effects:
(1) The model well solves non-coincidence of natural HRU boundary, administrative district boundary and irrigation area boundary by adopting a nested slope discretization method, which can not only give full play to the feature of unit division of a traditional distributed hydrological cycle model, but also meet the requirements for the integration of water resources region management and administrative region management;
(2) the embedded multi-source complementary water supply module can achieve joint allocation of multiple water sources and multiple industries in the social hydrological cycle, and meanwhile has the function of depicting multiple water sources (including urban river water, reservoir water, groundwater, transferred water, pit-pond water, etc.) and multiple projects (including water storage project, water diversion project, pumping engineering, water transfer project, etc.); by means of the embedded multi-source complementary water supply module, topological relationship between various water sources and water users in a water resources system, the transfer relationship of water in the precipitation-runoff process and in various social production departments are described objectively and clearly, making it possible to truly reflect the impact of human activities on the process of a hydrological cycle; and
(3) by adding the multi-source complementary water supply module and modifying the relevant modules of the SWAT model, a distributed model for simulating dynamic reciprocal between natural-artificial hydrological cycles is constructed, which makes up for the deficiency that previous hydrological cycle models cannot well reflect the interaction between the human activities of using water and the natural hydrological process; moreover, the model can achieve flexible access to different water sources according to the water demand during domestic production and the volume of water sources in the long sequence simulation, making it more suitable for areas with high-intensity human activities. Characterized by simulating dynamic reciprocation between natural-artificial hydrological cycles, and developing, utilizing and regulating water resources, the model realizes the function of simulating bidirectional coupling between natural hydrological cycle and artificial hydrological cycle, and fully reflects the dynamic and reciprocal characteristics of a complex hydrological cycle system, thus providing powerful support for reciprocal simulation between natural-artificial hydrological cycles of a region and fine management of a water resources system.

### BRIEF DESCRIPTION OF THE DRAWINGS

FIG. 1 is a flowchart illustrating a design method for a distributed hydrological cycle model based on a multi-source complementary water supply mode according to an embodiment of the present disclosure;

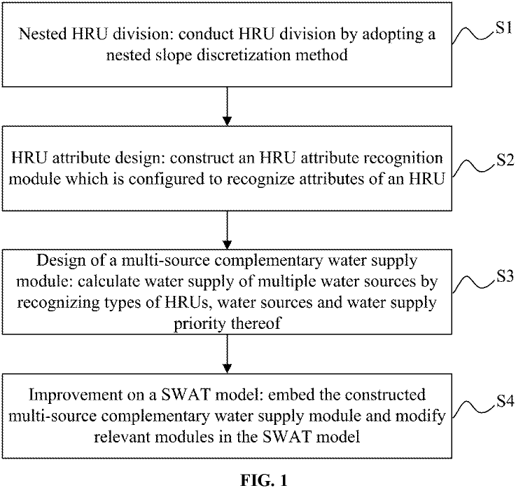

FIG. 2 is a flowchart illustrating HRU division according to an embodiment of the present disclosure;

FIG. 3 is a running flowchart of a multi-source complementary water supply module according to an embodiment of the present disclosure;

FIG. 4 is a flowchart illustrating calculation of water supply priority according to an embodiment of the present disclosure;

FIG. 5 shows comparison between actual measurement of a Xindianpu station and a simulated monthly runoff according to an embodiment of the present disclosure;

FIG. 6 is a relation diagram illustrating transformation of natural-artificial hydrological cycle of Baihe Basin in Level Year 2016; and

FIG. 7 is a diagram illustrating in-year water supply process of various water resources of Baihe Basin in Level Year 2016.

### DETAILED DESCRIPTION OF THE EMBODIMENTS

In order to make the objectives, technical solutions and advantages of the examples of the present disclosure clearer, the following clearly and completely describes the technical solutions in the examples of the present disclosure with reference to accompanying drawings in the examples of the present disclosure. Apparently, the described examples are some rather than all of the examples of the present disclosure. All other embodiments obtained by those of ordinary skill in the art based on the embodiments of the present disclosure without making inventive efforts shall fall within the scope of protection of the present disclosure.

Embodiments of the present disclosure provide a design method for a distributed hydrological cycle model based on a multi-source complementary water supply mode, the method mainly including the following four steps: nested HRU division; HRU attribute design, design of a multi-source complementary water supply module; and improvement on a SWAT model. The design of a multi-source complementary water supply module refers to the process of designing and adding relevant modules to add the functions of urban and rural multi-source water supply and multi-source irrigation simulation to the SWAT model, and improve artificial hydrological cycle, thus building a natural-artificial distributed hydrological cycle model. Improvement on the SWAT model refers to the process of modifying the relevant modules of the SWAT model to facilitate the reading of information about types, number, water source codes, and water withdrawal priority of water sources and the invocation of multi-source complementary module. Modules involved mainly include rchuse module, res module, watuse module, irr_rch module, irr_res module, irrsub module, subbasin module, percmain module, gwmod module, surface module, recday module, recmon module, main module, etc.

The method of the present includes the following steps:
Step S1: nested HRU division;
Step S2: HRU attribute design;
Step S3: design of a multi-source complementary water supply module; and
Step S4: improvement on a SWAT model.

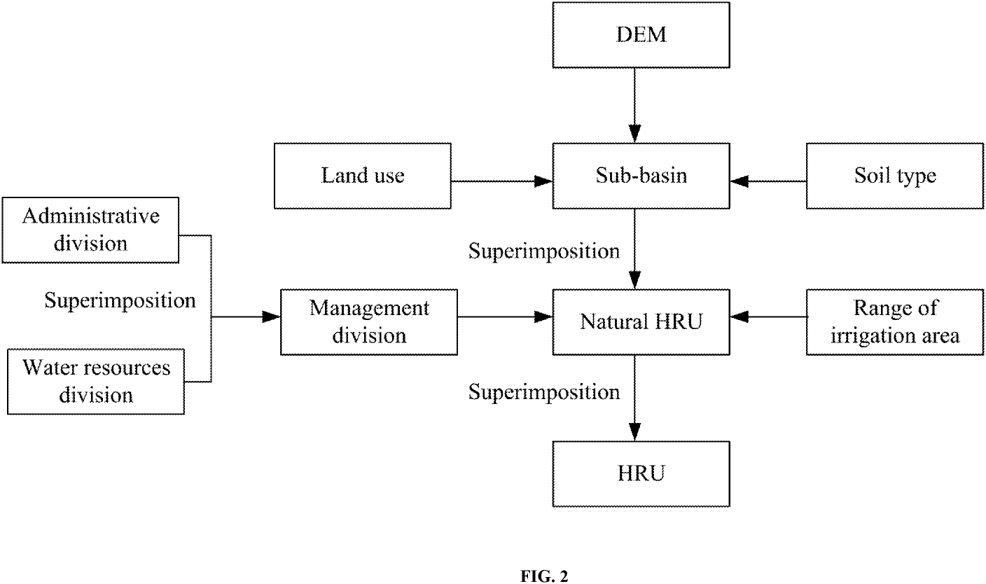

In step S1: HRU division is conducted by adopting a nested slope discretization method based on attributes of “basin, water resources region, administrative region, irrigation area, land use, soil and slope”. As shown in FIG. 2, step S1 mainly includes: (1) division of natural sub-basins; (2) division of natural HRUs; (3) superimposition of natural HRUs with an administrative unit; and (4) superimposition of natural HRUs with irrigation areas.
(1) Division of natural sub-basins is conducted by adopting Arc Hydro Tools in ArcGIS. Firstly, the correction operations such as depression filling are carried out on the DEM base map, and according to the set threshold requirements for generating Critical SourceArea (CSA) of sub-basins, the flow direction of a grid is determined, the waterline of the basin is identified, and division of the natural sub-basins is achieved based on the characteristic parameters of a river network such as slope, aspect and slope length of the basin;
(2) Superimposition is conducted according to the land use type, soil type and slope type in sub-basins to conduct division to obtain a plurality of natural HRUs. HRU refers to a region where underlying surfaces have relatively monotonous and uniform features, that is, underlying surfaces in this region have identical hydrological characteristics, and there is a merely a combination of one kind of plantation cover, one kind of soil and one kind of slope type within each HRU.
(3) A nest mode of superimposing HRUs with a prefecture-level / county-level administrative region and water resources region is adopted. By adopting the “EditorToolbar” function of GIS, a boundary GIS map of an administrative unit is directly superimposed onto a natural HRU map as obtained through division in the previous step. In a boundary region between the natural HRU and the management division, the natural HRU is divided into two parts according to the boundary line, and the HRUs obtained after division are endowed with attributes of the administrative unit;
(4) By adopting the “EditorToolbar” function of GIS, in a boundary region between the natural HRU and an irrigation area, the natural HRU is divided into two parts according to the boundary line, then the HRUs obtained after division are endowed with attributes of the irrigation area, thus completing division the HRU. Finally, each HRU has a sub-basin attribute, a water resources region attribute, an administrative region attribute, an irrigation area attribute, a land use type attribute and a soil type attribute.

Step S2 of HRU attribute design includes:
(1) construction of an HRU attribute recognition module readattr, which specifically includes:
   construct the HRU attribute recognition module readattr which is configured to read specified HRU attributes. Set HRU attributes are a sub-basin attribute, a water resources region attribute, an administrative region attribute, and an irrigation area attribute, respectively. The format of an input document can be found in Table 1.
(2) invoking the HRU attribute recognition module, which specifically includes
   putting the constructed readattr module (HRU attribute recognition module) in the main module in the SWAT model to facilitate invocation of the readattr module.

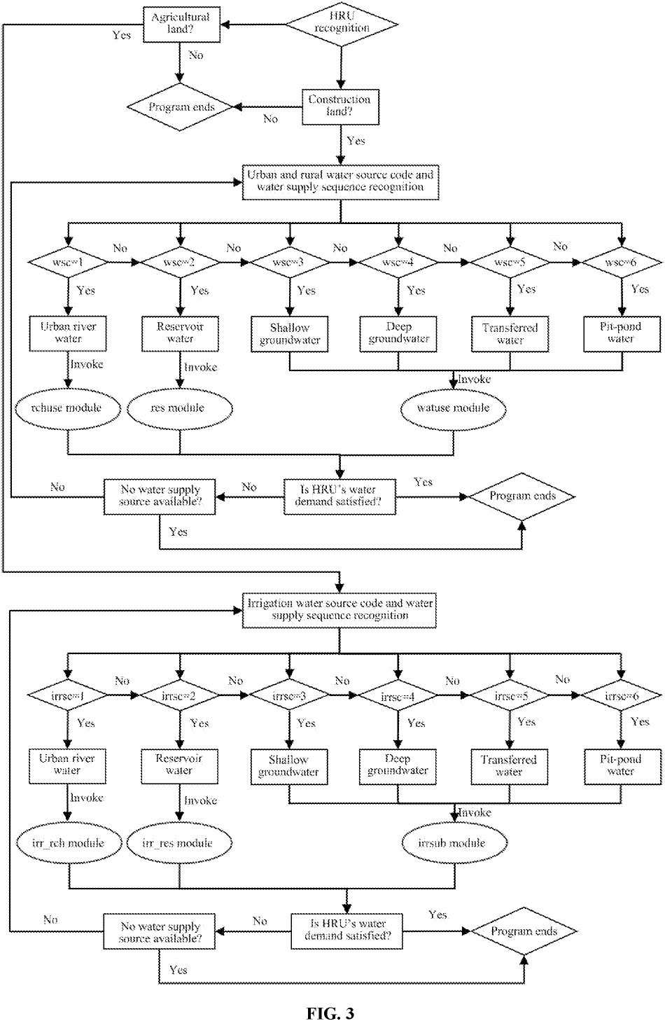

The design of a multi-source complementary water supply module in step S3 includes: (1) designing a water source code information file; (2) designing a water supply priority information file; and (3) designing calculation for multi-source complementary water supply.
(1) designing a water source code information file:
   the water source code information file is configured to read information about a specified water source. Six types of water sources are set and include transferred water, reservoir water, urban river water, shallow groundwater, deep groundwater and pit-pond water, and it is specified that every single HRU has at most 5 water sources of the same kind, that is, at most 30 water sources can be disposed for each HRU. Water source codes are specified in a way of reading an input document based on different types of HRUs; for residential and industrial land HRUs, specification is conducted with the administrative region as a unit, and HRUs within the same administrative region have consistent water sources; and for irrigation area HRUs, specification is conducted with the administrative region as a unit, and HRUs within the same irrigation area have consistent water sources. The format of the input document can be found in Table 2 and Table 3, respectively.
(2) designing a water supply priority information file:
   the water supply priority information file is configured to read information about a specified water supply priority of a water source. Each water source is accessible to a plurality of HRUs, and meanwhile, each HRU can withdraw water from a plurality of water sources. A water supply sequence is set according to the type and number of water sources for each HRU. The water supply priority of water sources is specified in a way of reading an input document based on different types of HRUs; for residential and industrial land HRUs, specification is conducted with the administrative region as a unit, and HRUs within the same administrative region have consistent water supply priority; and for irrigation area HRUs, specification is conducted with the administrative region as a unit, and HRUs within the same irrigation area have consistent water supply priority. The priority is set from 1 to k (k denotes the number of water sources for HRU, k≤30), 1 denotes the highest priority, and the sequence number is set to 0 for unspecified water sources. The format of the input document can be found in Table 4 and Table 5.
(3) designing a water withdrawal control information file:
   which is configured to read information about annual water supply control volume of each administrative region. Each HRU recognizes an annual surface water supply control volume and an annual groundwater exploitation control volume of an administrative region to which the HRU belongs based on attributes of the administrative region for the subsequent calculation of water withdrawal volume of water sources. The format of an input document can be found in Table 6.
(4) designing calculation for multi-source complementary water supply:
   as shown in FIG. 3, the running process of the multi-source complementary water supply module Multi _sc mainly includes: 1) recognizing types of HRUs; 2) recognizing the water source and priority thereof; and 3) calculating multi-source complementary water supply.

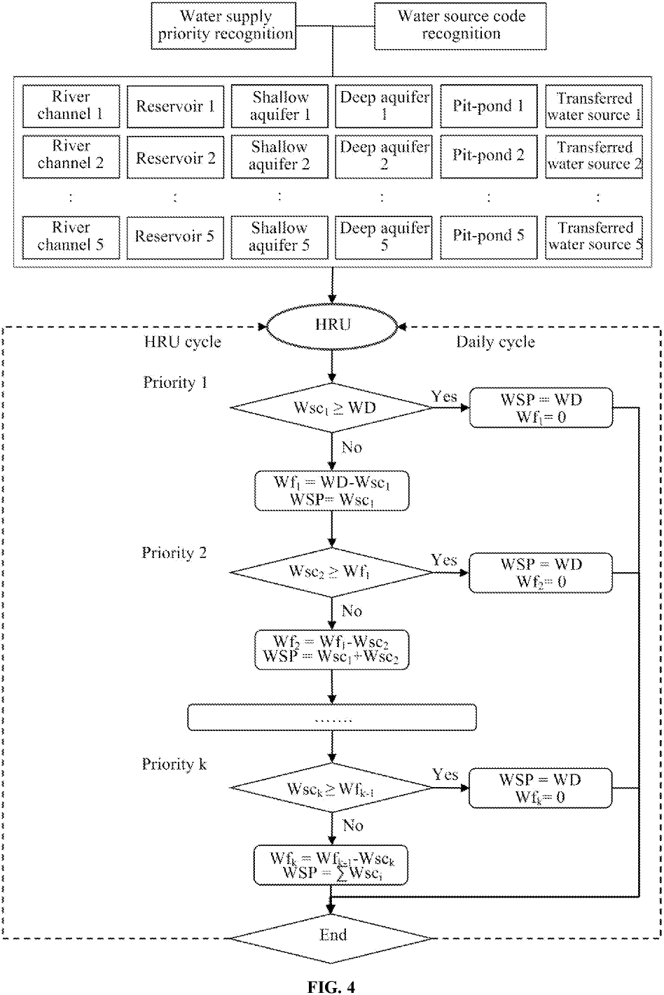

1) recognizing types of HRUs, which specifically includes
   first, recognizing the land use type of an HRU, where if it is construction land (urban land and rural land), a program enters a calculation process for urban and rural water supply; if it is irrigation land, the program enters a calculation process for irrigation water; and if it is other land use type, the HRU has no requirement for water supply, and the program ends.
2) recognizing the water source and priority thereof, which specifically includes
   using the multi-source complementary water supply mode to revoke corresponding water source modules by recognizing water withdrawal source identification codes of an HRU, where the water withdrawal source identification codes for urban river water, reservoir water, shallow groundwater, deep groundwater, transferred water and pit-pond water are 1, 2, 3, 4, 5, and 6, respectively. The number, type and water withdrawal sequence of water sources of each HRU are recognized by reading the water source code information file and water supply priority information file, and each water source module is revoked in turn according to the water withdrawal source identification code.
3) calculating multi-source complementary water supply, which specifically includes
using the multi-source complementary water supply module to seek water sources and conducting water withdrawal from each water source according to a water supply sequence of the HRU until the HRU’s daily demand for domestic water (construction land HRU), industrial water, and agricultural irrigation water (agricultural land HRU) is satisfies or until the last water source finishes water supply. As shown in FIG. 4, calculation of water supply priority includes:
1) specifying a daily water demand WD set by a target HRU;
2) recognizing the number k (k≤30), water source codes and water supply priority of water sources of the target HRU; and
3) invoking water source modules in sequence to calculate the water withdrawal of the water sources. The water source modules include a rchuse module, a res module and a watuse module. The water withdrawal volume of the water source depends on a daily water demand of the HRU and an available water supply of the water source. The available water supply depends on an accessible water volume of the water source, the water supply capacity of a water withdrawal project (such as water diversion channels, water supply pipelines, and power-driven wells) and the water withdrawal control volume. The calculation formulas are as follows:
$$W S P {}_{i j} = min \left(W {D}_{i} - {\sum }_{k = 1}^{j - 1} W S {P}_{k} , W s {c}_{i j}\right)$$
$$W s {c}_{i j} = min \left(W {A}_{i j} , W {F}_{i} , W M {X}_{i j} - {\sum }_{k = 1}^{j - 1} W S {P}_{k}\right)$$
$$W M {X}_{i j} = \left\{\begin{matrix}m i n ( W U M - {\sum }_{m = 1}^{i - 1} {\sum }_{k = 1}^{j} W S {P}_{k} , W S M - {\sum }_{m = 1}^{i - 1} {\sum }_{k = 1}^{j} W S {P}_{k} ) \\ m i n ( W U M - {\sum }_{m = 1}^{i - 1} {\sum }_{k = 1}^{j} W S {P}_{k} , W G M - {\sum }_{m = 1}^{i - 1} {\sum }_{k = 1}^{j} W S {P}_{k} )\end{matrix}\right)$$
where, i denotes a sequence number of an HRU; j denotes a water supply priority number of a water source; WSP denotes an actual daily water withdrawal volume (m³) of a water source; WD indicates a daily water demand (m³) of an HRU; Wsc indicates a daily available water supply (m³) of a water source; WF indicates the water supply capacity (m³) of a water withdrawal project; WA indicates a daily accessible water volume of a water source (m³); WMX denotes an annual water withdrawal control volume (m³), and WUM denotes an annual water consumption control volume (m³); WSM denotes an annual surface water withdrawal control volume (m³); and WGM denotes an annual groundwater exploitation control volume (m³).
4) For a water source with a water supply priority of 1, priority is given to water withdrawal from the water source. If the available water supply of the water source is Wsc₁>WD, then the water supply of the water source is WSP₁=WD, a water supply program ends, and the water supply of the water source of the HRU is WSP= WSP₁; otherwise, WSP₁=Wsc₁, and the water demand of the HRU changes to Wf =WD-Wsci, and the program will continue to seek the next grade of water source;
5) for a water source with a water supply priority of j (j=2, ..., k-1; k≤30), if the daily available water supply of the water source is Wscⱼ>Wf, then the water supply of the water source is WSPⱼ=Wf, the program ends, and the total water supply of the water source the HRU is SP=WSP+WSPⱼ; otherwise, WSPⱼ=Wscⱼ, the water demand of the HRU changes to Wf=Wf-Wscⱼ, and the program will continue to seek the next grade of water source; and
6) for a water source with a water supply priority of k (k≤30), if the daily available water supply of the water source is Wscₖ>Wf, then the water supply of the water source is WSPₖ=Wf, the program ends, and the total water supply of the HRU is WSP=∑WSPᵢ; otherwise, WSPₖ=Wscₖ, the water demand of the HRU changes to Wf=Wf-Wscₖ, and the program ends.

In step S4, improvement on the SWAT model mainly involves connecting the multi-source complementary water supply module with modified modules in a SWAT model to realize real-time data exchange, where the HRU allocates and regulates water resources according to input information about water demand, types of water sources, rules of water supply priority, and water conservancy projects, and information about natural hydrological conditions which is provided by the SWAT model, and outputs and transfers information about an artificial hydrological cycle regarding daily “water supply, water use, water consumption, water drainage” to the SWAT model. The relevant modules of the SWAT model are modified to facilitate the reading of information about types, number, water source codes, and water withdrawal priority of water sources and the invocation of multi-source complementary module. The modified modules mainly include rchuse module, res module, watuse module, irr_rch module, irr_res module, irrsub module, subbasin module, surface module, gwmod module, recday module, recmon module, main module, etc. The main functions of each module are as follows:

rchuse module: the river channel water supply module, which is configured to conduct water withdrawal from a designated river channel for domestic and industrial water.

res module: a reservoir water supply module, which is configured to conduct water withdrawal from a designated reservoir for domestic and industrial water.

watuse module: a groundwater and pit-pond water supply module, which is configured to conduct water withdrawal from a shallow underground aquifer, a deep underground aquifer and pit-ponds in a designated sub-basin for domestic and industrial water.

irr_rch module: a river channel irrigation module, which is configured to conduct water withdrawal from a designated river channel for farmland irrigation.

irr_res: a reservoir irrigation module, which is configured to conduct water withdrawal from a designated reservoir for farmland irrigation.

irrsub module: a groundwater and transferred water irrigation module, which is configured to conduct water withdrawal from a shallow underground aquifer, a deep underground aquifer and an external water source in a designated sub-basin.

percmain module: a leakage loss module, which is configured to simulate moisture change in soil according to the calculation results of precipitation infiltration, irrigation infiltration and pit-pond infiltration.

gwmod module: a groundwater module, which is configured to simulate the variation in shallow groundwater and deep groundwater according to the results of surface water infiltration.

subbasin module: a sub-basin module, which mainly conducts evaporation simulation, runoff producing simulation, groundwater simulation, vegetation growth simulation, farmland management simulation, nutrient migration and transformation simulation, etc., which is realized by invoking modules related to the hydrological and water-quality process.

surface module: an earth surface runoff simulation module, which is configured to simulate hydrological processes of primary surface water such as canopy interception, accumulated snow and snowmelt, and earth surface runoff.

recday module: a daily point source module, which is configured to simulate the changing process of daily point sources by inputting daily pollutant emissions.

recmon module: a monthly point-source module, which is configured to simulate the changing process of monthly point sources by inputting monthly pollutant emissions.

main module; a main module of the SWAT model, which is mainly configured to read input documents, allocating array size, initializing parameters, simulating the hydrological process and so on.

Modification of relevant modules in the SWAT model specifically includes:

### Shielding Modules

Shield the water source modules, namely the rchuse module, the res module, the watuse module, the irr_rch module, the irr_res module and the irrsub module, and forgo adopting a single water source withdrawal mode; and put the foregoing modules into the multi-source complementary water supply module for invoking.

### Modifying the Rchuse Module and the Res Module

Add codes separately, and replace parameters waterrch and wuresn in the rchuse module and the res module with parameter WSPᵢ (i=1,2) respectively to achieve connection of the multi-source complementary water supply module Multi_sc with the rchuse module and the res module well as invoking;

### Modifying the Watuse Module

1) Modify programs to add functions of transferred water withdrawal and transferred water volume restriction so as to control water supply within a total transferred water limit given that the module does not have the function of transferred water supply, where a calculation formula is expressed as follows:

$${\sum }_{i} {\sum }_{j} \text{waterout} \left(i , j\right) \leq M X 5$$

where waterout (i,j) denotes transferred water consumption (m³) of the jth HRU on the ith day; and WX5 denotes total transferred water limit (m³).

2) Add codes in the watuse module, and replacing parameters watershal, waterdeep, waterout, and waterpnd in the watuse module with parameter WSPᵢ (i=3,4,5,6), respectively to achieve connection of the multi-source complementary water supply module Multi_sc with the watuse module as well as invoking.

### Adding a Function of Simulating Water Delivery of a Pipe Network

In order to resolve loss in urban water supply caused when water “escapes, overflows, drips or leaks” due to aging or breakage of a pipe network, add a calculation program code of the following formula in the rchuse module, the res module, and the watuse module:

$$W S P = W S P ⋅ \left(1 - p i p\right)$$

where, pip denotes a leakage rate of water supply pipe network.

### Modifying the Irrsub Module

In terms of the absence of a pit-pond irrigation function in the module, add the pit-pond irrigation function; completing a transferred water irrigation function; and impose water supply restriction to control an irrigation water withdrawal within the total transferred water limit.

$${\sum }_{i} {\sum }_{j} \text{wirrout} \left(i , j\right) \leq M X 5$$

$${\sum }_{i} {\sum }_{j} \text{wirrpnt} \left(i , j\right) \leq M X 6$$

where wirrout (i,j) denotes transferred water irrigation consumption (m³) of the jth HRU on the ith day; and WX5 denotes total transferred water limit (m³). wirrpnt (i,j) denotes pit-pond irrigation consumption (m³) of the jth HRU on the ith day; and WX6 denotes pit-pond available water supply (m³).

### Adding a Function of Simulating an Irrigation Channel

1) Given that the SWAT model does not consider the influence of water delivery loss of an irrigation channel on a hydrological cycle, irrigation-related leakage is deemed as system loss, add modify the irr_rch module, the irr_res module, and the irrsub module to add simulation on a channel system delivery process comprising channel water loss and channel recession, where the channel water loss includes two parts of channel water evaporation loss and channel leakage loss, and the main calculation formulas are as follows:

$$E {T}_{c a n} = I R {R}_{c a n} ⋅ \left(1 - φ\right) ⋅ α$$

$$L {s}_{c a n} = I R {R}_{c a n} ⋅ \left(1 - φ\right) ⋅ β$$

$$S u r p {}_{c a n} = I R {R}_{c a n} ⋅ \left(1 - φ\right) ⋅ \left(1 - α - β\right)$$

where, ET_{can} denotes a channel system evaporation loss (mm); IRR_{can} denotes an irrigation water volume (mm) entering a channel; Ls_{can} denotes a channel system leakage loss (mm); Surp_{can} denotes a channel system recession volume (mm); φ denotes an effective utilization coefficient of channel system water; α denotes a channel system evaporation coefficient; and β denotes a channel system leakage coefficient.

2) Drive water from leakage loss to enter upper soil as replenished soil water and participate in the soil moisture cycle, and add a calculation program for leakage loss by modifying relevant codes of a percmain module, and the calculation formula is as follows:

$$W s {l}_{y r 1 , t} = W s {l}_{y r 1 , t - 1} + {inf}_{p c p} + {inf}_{i r r} + {inf}_{w e t} + L {s}_{c a n}$$

where,

$$W s {l}_{y r 1 , t + 1}$$

denotes soil water content (mm) of a first layer of soil on the t-th day;

$$W s {l}_{y r 1 , t}$$

denotes soil water content (mm) of a first layer of soil on the (t-1)th day; inf_{pcp} denotes precipitation infiltration capacity (mm); infᵢᵣᵣ denotes irrigation infiltration capacity (mm); and inf_{wet} denotes lake and reservoir wetland infiltration capacity (mm);

### Modifying Codes of the Gwmod Module

Drive water loss from leakage of a water supply pipe network to enter an underground aquifer as replenished groundwater, and modify groundwater recharge codes in a gwmod module to achieve simulation on water leakage of a pipe network, and the calculation formula is as follows:

$$\begin{matrix}r h {}_{ε} = \left(1 - exp \left(- 1 / G W \_ D E L A Y\right)\right) ⋅ \left(p r c + W S P ⋅ p i p / A r e a\right) \\ + exp \left(- 1 / G W \_ D E L A Y\right) ⋅ r {h}_{L - 1}\end{matrix}$$

where,

$$r {h}_{t}$$

denotes groundwater recharge capacity (mm) on the t-th day;

$$r {h}_{t - 1}$$

denotes groundwater recharge capacity (mm) on the (t-1)th day; prc denotes soil water leakage (mm) of recharged groundwater; GW_DELAY denotes groundwater recharge delay coefficient (mm); and Area denotes the area (m²) of an HRU;

### Modifying the Subbasin Module

Add the multi-source complementary water supply module in a subbasin module to facilitate revoking during the running of the SWAT model, and conduct in-year dynamic complementary water supply operation on water sources by reading specified type, number, water source codes, water withdrawal volume, and water withdrawal time of water sources to achieve multi-source combined water supply simulation during the running of the SWAT model.

### Modifying the Surface Module

Channel system recession refers to irrigation water discharged and overdrawn from the channel, which directly enters the river channel and participates in the calculation of flow concentration of river channel, and superimpose the earth surface runoff by modifying the relevant codes of the surface module, and the calculation formula is as follows:

$$s u r {f}_{t} = s u r {f}_{0} + S u r {p}_{c a n}$$

where,

$$s u r {f}_{t}$$

denotes runoff (mm) after channel recession; and

$$s u r {f}_{0}$$

denotes runoff (mm) before channel recession.

### Modifying the Point Source Module

After urban domestic and industrial sewage is produced, it is directly discharged into the river through the drainage pipe network system, or transported to the sewage disposal plant for disposal. Some of the up-to-standard sewage obtained after disposal is directly discharged into the river, and some of the up-to-standard reclaimed water obtained after advanced disposal is reused for greening, domestic miscellaneous use, production and other purposes. The SWAT model conducts simulation using a point source module (recday module or recmon module). Modify relevant codes in the recday module and recmon module, and use a pollution discharge parameter WDR to replace parameters floday and flomon, respectively, and the calculation formulas are as follows:

$$W P = W S P ⋅ \left(1 - r\right)$$

$$W D R = W P ⋅ \left(1 - v\right) + W P ⋅ v ⋅ \left(1 - r e\right)$$

where WDR denotes urban sewage output (m³); WP denotes sewage discharge (m³); r denotes a water consumption rate; v denotes a sewage disposal rate of a sewage disposal plant; and re denotes a reclaimed water utilization rate.

### Modifying the Main Module

Put the constructed readattr module in the main module in the SWAT model to facilitate invocation of the readattr module.

Modify SWAT source codes in the Windows platform application development environment Visual Studio 2012 using Fortran language based on the foregoing structures, which achieves revocation of a multi-source complementary water supply module with the functions of urban multi-source supply and multi-source agricultural irrigation. Therefore, a SWAT model based distributed model for simulating bidirectional reciprocation of natural-artificial hydrological cycles with the function of multi-source complementation is constructed.

The present disclosure selects Baihe Basin as an embodiment, and the simulation process of the natural-artificial hydrological cycle in Baihe Basin is described as follows:

### 1. Overview of Study Area

Suited in the middle part of the Hanjiang River basin, Baihe Basin runs from Funiu Mountain in the north to the Hanjiang River in the south, bordering Laoguan River in the west and Tang River Basin in the east. With most of regions located in the Nanyang Basin, Baihe Basin covers a total area of 12,300 km². Baihe Basin exhibits a tendency of elevating from south to north. Its river systems mainly cover Baihe and its tributaries including Tuan River, the turbulent River, Diao River and Yanling River. The mean annual gross amount of water resources reaches 2.08 billion m³. Within the basin, there are 3 prefecture-level cities including Nanyang City, Henan Province, as well as Xiangyang City, Hubei Province, and a total of 12 county-level administrative units including Wolong District and Wancheng District, Xinye County and Xiangzhou District. Baihe Basin covers 4 large-sized irrigation areas such as Yahekou irrigation area and Yindan irrigation area, and 18 medium-sized irrigation areas such as Zhaowan reservoir irrigation area, Gaoqiu reservoir irrigation area and Doupo reservoir irrigation area. In order to achieve flood control and drought relief and ensure accessibility of agricultural irrigation water, there are one large-sized reservoir (Yahekou Reservoir) and more than a dozen medium-sized reservoirs such as Zhaowan Reservoir, Hushan Reservoir, Doupo Reservoir and Guangou Reservoir.

### 2. Basic Data Collection

Data required for the construction of the model include spatial data, covering DEM (90 m×90 m), land use map (1:100000), soil distribution map (1:1000000), administrative region distribution map, irrigation area distribution map, and water system map, etc; meteorological data from 1990 through 2016 of four meteorological stations in and adjoining the Baihe Basin, including daily precipitation, daily maximum and minimum temperature, relative humidity, sunshine duration, wind speed, and other meteorological elements; water conservancy project data, mainly including reservoir location, inactive reservoir capacity, regulated reservoir capacity, total reservoir capacity, discharge capacity of irrigation channels, and daily water pumping capacity of motor-driven wells; monthly runoff data of Xindianpu Hydrological Station from 1991 through 2016 used for model calibration and validation; data about agricultural irrigation water over the years, which is obtainable by querying Nanyang City Water Resources Bulletin and Xiangyang City Water Resources Bulletin during 2006 - 2016; and data about irrigation areas and plantation structures, including plantation areas of wheat, rice, peanuts, rape, sesame, cotton, vegetables, melons and fruits and other crops. In addition, it is necessary to collect basic information about the time, frequency and quantity of single (irrigation, fertilization) related to crop management measures such as sowing, irrigation, fertilization and harvesting.

### 3. Modeling Process

In combination with the water resources distribution, characteristics of water conservancy project, and water withdrawal and utilization of various industries in the Baihe Basin, model building includes the following steps:

(1) HRU division: obtain, by division, a total of 34 natural sub-basins and 507 natural HRUs according to DEM data, land-use type map and soil type map; and on this basis, subdivide natural HRUs into 1,027 HRUs according to administrative division and distribution of irrigation areas, the HRUs each having a sub-basin attribute, a water resources region attribute, an administrative region attribute, an irrigation area attribute, a land use type attribute and a soil type attribute.

(2) Input of information about agricultural plantation and management, including crop types, crop planting area and irrigation area, crop rotation system and irrigation system in administrative regions and counties.

(3) Input of information about water supply rules, mainly including information such as water supply objects, regional water supply principle, water supply priority, water distribution principle of water users, type and number of water sources, and industry water use priority; in addition, the information that needs to be input also includes information about water conservancy projects such as reservoirs, channels, motor-driven wells, effective utilization coefficient of channel system water, effective utilization coefficient of field water, water consumption rate and so on.

(4) Input of meteorological data information: input data about established precipitation, air temperature, wind speed, radiation and relative humidity, afterwards, input all attribute data and reservoir data, and then start running after the construction of the model is completed.

### 4. Parameter Calibration and Model Validation

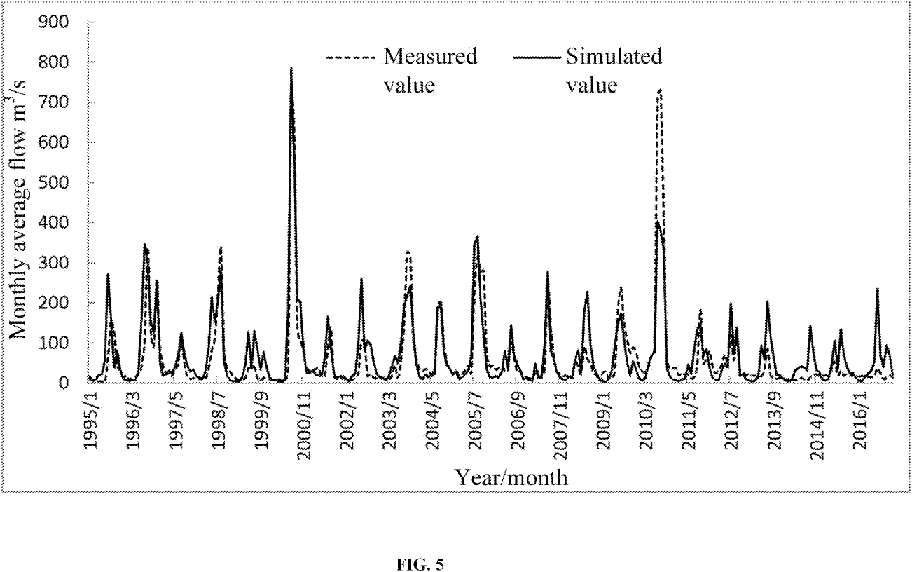

Through the above process and analysis, the main parameter values of the model are determined, and the final values after parameter adjustment are shown in Table 7. Through adjustment in the parameters of the model, the results of comparison between the simulated and measured runoff of the model are shown in Table 8 and FIG. 5. In the calibration period (1995-2005), the correlation coefficient between monthly runoff simulation value and measured value in Xindianpu station is 0.792, and the Nash-Sutcliffe efficiency coefficient is 0.756; in the validation period (2006-2016), the correlation coefficient between monthly runoff simulation value and measured value in Xindianpu station is 0.643, and the Nash-Sutcliffe efficiency coefficient is 0.635. The results show that the fitting degree of the monthly runoff simulated value and measured value is high, and the simulation accuracy of the model reaches the required value.

The deviation percentages of the simulation results of all administrative regions (Wolong District, Wancheng District, and Zhenping County) located in the basin are shown in Table 9. As can be seen from this table, the water supply volumes of the three counties (districts) from 2010 through 2016 have seen a slight deviation, in which deviations of domestic water consumption, industrial water consumption, agricultural water consumption, surface water supply and groundwater supply from actual water volumes are all within 10%. As can be seen, simulation results of the model well reflect actual water consumption and supply in the Baihe Basin.

### 5. Analysis of Simulation Results

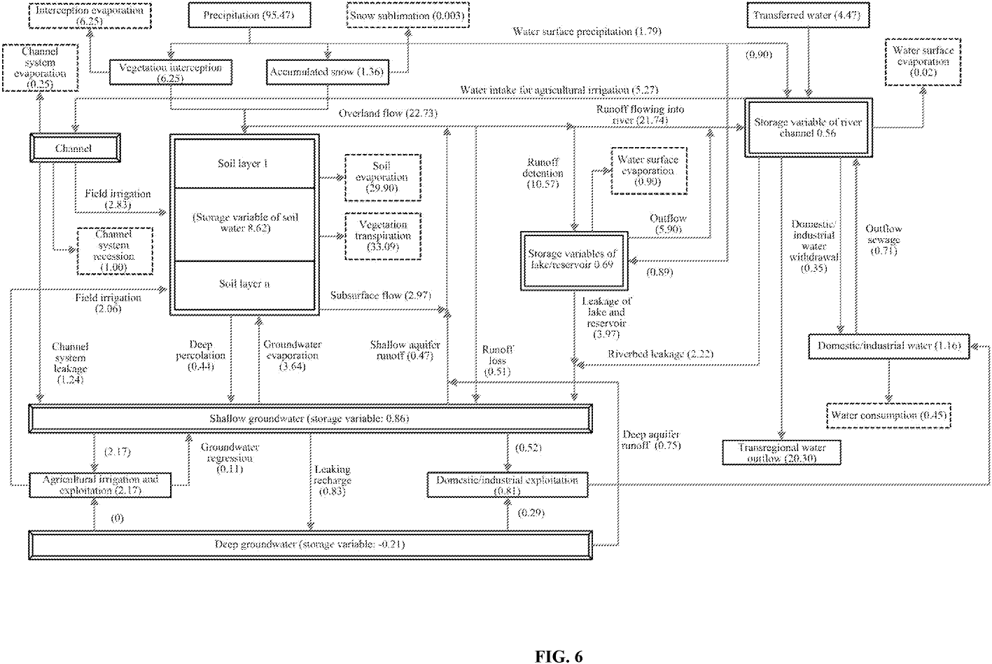

Through the simulation and summary of hydrological cycle in Baihe Basin in 2016, the relationship of cycle transformation in water resources in the Basin is shown in FIG. 6. In 2016, the whole basin saw 9,547 million m³ of total precipitation, 2,273 million m³ of earth surface runoff, 862 million m³ of year-end soil water storage variable, 125 million m³ of surface water storage variable, and 65 million m³ of groundwater storage variable. The whole basin saw 7,061 million m³ of total water consumption, including 2,990 million m³ of soil evaporation, 3,309 million m³ of vegetation transpiration, 625 million m³ of interception evaporation, 0.3 million m³ of snow sublimation, 117 million m³ of water surface evaporation, and 45 million m³ of domestic and industrial consumption. When the consumption of transferred water is considered, the whole basin saw 953 million m³ of total economic and social water consumption, including 621 million m³ of surface water consumption (including 447 million m³ of transferred water) and 332 million m³ of groundwater consumption; and moreover, the whole basin saw 534 million m3 of total artificial water consumption, 171 million m³ of artificial displacement, and 2,030 million m³ of total 9.

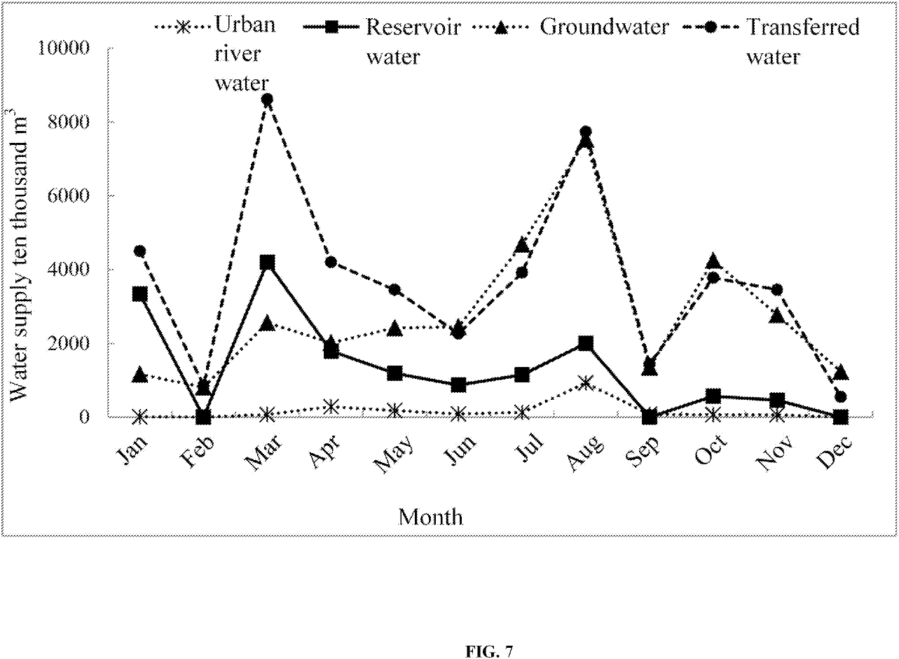

The water supply of water sources in the Baihe Basin in 2016 is summarized in FIG. 7. In 2016, water sources in Baihe Basin mainly centered around groundwater and transferred water (supplied by Danjiangkou Reservoir). Throughout the year, the development and consumption of groundwater accounted for 34.83% (332 million m³) of the total water consumption in the Basin, the consumption of transferred water accounted for 46.92% (447 million m³) of the total water consumption in the Basin, and the consumption of urban river water came last, which only accounted for 1.95% (18 million m³) of the total water consumption in the Basin. Throughout the year, peak of water consumption appeared in March and August. March is the key period of water consumption for winter wheat, and during this period, the consumption of transferred water is 86 million m³, followed by water storage and water supply (42 million m³); given that the surface water resources are relatively abundant, groundwater is only used for supplementary water supply, and the supplementary water supply is 26 million m³. August is the key period of water consumption for maize growth, and during this period, the consumption of transferred water is 77 million m³, water storage resources are inadequate and thus can only supply 20 million m³ of water, while groundwater plays an important role in supplementary water supply, and can supply 75 million m³ of water, which is almost equal to the supply of transferred water. In addition, the small peak of water consumption appeared from October to November and in January, mainly due to the irrigation water after winter wheat was planted. During this period, there are limited surface water resources, water is mainly supplied from Danjiangkou Reservoir (transferred water) and groundwater for supplementary irrigation.

TABLE 1

| | | | | |
|---|---|---|---|---|
| HRU code | Sub-basin attribute | Water resources region attribute | Administrative region attribute | Irrigation area attribute |
| Field format | Shaping | Shaping | Shaping | Shaping |
| Note | Code of sub-basin | Code of water resources region | Code of administrative region | Code of irrigation area |
| Content | Code of sub-basin to which an HRU belongs | Code of water resources region to which an HRU belongs | Code of administrative region to which an HRU belongs | Code of irrigation area to which an HRU belongs |

TABLE 2

| | | | |
|---|---|---|---|
| Parameter name | Data type | Note | Content |
| cntyID | Shaping | Code of administrative region | Sequence number of administrative region |
| Riv1 | Shaping | No. 1 urban river water source | Code of sub-basin where a river channel lies |
| Riv2 | Shaping | No. 2 urban river water source | Code of sub-basin where a river channel lies |
| Riv3 | Shaping | No. 3 urban river water source | Code of sub-basin where a river channel lies |
| Riv4 | Shaping | No. 4 urban river water source | Code of sub-basin where a river channel lies |
| Riv5 | Shaping | No. 5 urban river water source | Code of sub-basin where a river channel lies |
| Res1 | Shaping | No. 1 reservoir water source | Code of reservoir |
| Res2 | Shaping | No. 2 reservoir water source | Code of reservoir |
| Res3 | Shaping | No. 3 reservoir water source | Code of reservoir |
| Res4 | Shaping | No. 4 reservoir water source | Code of reservoir |
| Res5 | Shaping | No. 5 reservoir water source | Code of reservoir |
| Shall | Shaping | No. 1 shallow water source | Code of sub-basin where a shallow water layer lies |
| Shal2 | Shaping | No. 2 shallow water source | Code of sub-basin where a shallow water layer lies |
| Shal3 | Shaping | No. 3 shallow water source | Code of sub-basin where a shallow water layer lies |
| Shal4 | Shaping | No. 4 shallow water source | Code of sub-basin where a shallow water layer lies |
| Shal5 | Shaping | No. 5 shallow water source | Code of sub-basin where a shallow water layer lies |
| Deep1 | Shaping | No. 1 deep water source | Code of sub-basin where a deep water layer lies |
| Deep2 | Shaping | No. 2 deep water source | Code of sub-basin where a deep water layer lies |
| Deep3 | Shaping | No. 3 deep water source | Code of sub-basin where a deep water layer lies |
| Deep4 | Shaping | No. 4 deep water source | Code of sub-basin where a deep water layer lies |
| Deep5 | Shaping | No. 5 deep water source | Code of sub-basin where a deep water layer lies |
| Out1 | Shaping | No. 1 pit-pond water source | Code of sub-basin where a pit-pond lies |
| Out2 | Shaping | No. 2 pit-pond water source | Code of sub-basin where a pit-pond lies |
| Out3 | Shaping | No. 3 pit-pond water source | Code of sub-basin where a pit-pond lies |
| Out4 | Shaping | No. 4 pit-pond water source | Code of sub-basin where a pit-pond lies |
| Out5 | Shaping | No. 5 pit-pond water source | Code of sub-basin where a pit-pond lies |
| Pnd1 | Shaping | No. 1 external-basin water source | Code of external water |
| Pnd2 | Shaping | No. 2 external-basin water source | Code of external water |
| Pnd3 | Shaping | No. 3 external-basin water source | Code of external water |
| Pnd4 | Shaping | No. 4 external-basin water source | Code of external water |
| Pnd5 | Shaping | No. 5 external-basin water source | Code of external water |

If there is no water supply in Table 2, the code is represented by 0.

TABLE 3

| | | | |
|---|---|---|---|
| Parameter name | Data type | Note | Content |
| irrID | Shaping | Code of irrigation area | Sequence number of irrigation area |
| Riv1 | Shaping | No. 1 urban river water source | Code of sub-basin where a river channel lies |
| Riv2 | Shaping | No. 2 urban river water source | Code of sub-basin where a river channel lies |
| Riv3 | Shaping | No. 3 urban river water source | Code of sub-basin where a river channel lies |
| Riv4 | Shaping | No. 4 urban river water source | Code of sub-basin where a river channel lies |
| Riv5 | Shaping | No. 5 urban river water source | Code of sub-basin where a river channel lies |
| Res1 | Shaping | No. 1 reservoir water source | Code of reservoir |
| Res2 | Shaping | No. 2 reservoir water source | Code of reservoir |
| Res3 | Shaping | No. 3 reservoir water source | Code of reservoir |
| Res4 | Shaping | No. 4 reservoir water source | Code of reservoir |
| Res5 | Shaping | No. 5 reservoir water source | Code of reservoir |
| Shal1 | Shaping | No. 1 shallow water source | Code of sub-basin where a shallow water layer lies |
| Shal2 | Shaping | No. 2 shallow water source | Code of sub-basin where a shallow water layer lies |
| Shal3 | Shaping | No. 3 shallow water source | Code of sub-basin where a shallow water layer lies |
| Shal4 | Shaping | No. 4 shallow water source | Code of sub-basin where a shallow water layer lies |
| Shal5 | Shaping | No. 5 shallow water source | Code of sub-basin where a shallow water layer lies |
| Deep1 | Shaping | No. 1 deep water source | Code of sub-basin where a deep water layer lies |
| Deep2 | Shaping | No. 2 deep water source | Code of sub-basin where a deep water layer lies |
| Deep3 | Shaping | No. 3 deep water source | Code of sub-basin where a deep water layer lies |
| Deep4 | Shaping | No. 4 deep water source | Code of sub-basin where a deep water layer lies |
| Deep5 | Shaping | No. 5 deep water source | Code of sub-basin where a deep water layer lies |
| Out1 | Shaping | No. 1 pit-pond water source | Code of sub-basin where a pit-pond lies |
| Out2 | Shaping | No. 2 pit-pond water source | Code of sub-basin where a pit-pond lies |
| Out3 | Shaping | No. 3 pit-pond water source | Code of sub-basin where a pit-pond lies |
| Out4 | Shaping | No. 4 pit-pond water source | Code of sub-basin where a pit-pond lies |
| Out5 | Shaping | No. 5 pit-pond water source | Code of sub-basin where a pit-pond lies |
| Pnd1 | Shaping | No. 1 external-basin water source | Code of external water |
| Pnd2 | Shaping | No. 2 external-basin water source | Code of external water |
| Pnd3 | Shaping | No. 3 external-basin water source | Code of external water |
| Pnd4 | Shaping | No. 4 external-basin water source | Code of external water |
| Pnd5 | Shaping | No. 5 external-basin water source | Code of external water |

If there is no water supply in Table 3, the code is represented by 0.

TABLE 4

| Parameter name | Data type | Note | Content |
|---|---|---|---|
| cntyID | Shaping | Code of administrative region | Sequence number of administrative region |
| sup_Riv1 | Shaping | Water withdrawal sequence number of No. 1 urban river water source | Code of water supply sequence number |
| sup_Riv2 | Shaping | Water withdrawal sequence number of No. 2 urban river water source | Code of water supply sequence number |
| sup_Riv3 | Shaping | Water withdrawal sequence number of No. 3 urban river water source | Code of water supply sequence number |
| sup_Riv4 | Shaping | Water withdrawal sequence number of No. 4 urban river water source | Code of water supply sequence number |
| sup_Riv5 | Shaping | Water withdrawal sequence number of No. 5 urban river water source | Code of water supply sequence number |
| sup_Res1 | Shaping | Water withdrawal sequence number of No. 1 reservoir water source | Code of water supply sequence number |
| sup_Res2 | Shaping | Water withdrawal sequence number of No. 2 reservoir water source | Code of water supply sequence number |
| sup_Res3 | Shaping | Water withdrawal sequence number of No. 3 reservoir water source | Code of water supply sequence number |
| sup_Res4 | Shaping | Water withdrawal sequence number of No. 4 reservoir water source | Code of water supply sequence number |
| sup_Res5 | Shaping | Water withdrawal sequence number of No. 5 reservoir water source | Code of water supply sequence number |
| sup_Shal1 | Shaping | Water withdrawal sequence number of No. 1 shallow water source | Code of water supply sequence number |
| sup_Shal2 | Shaping | Water withdrawal sequence number of No. 2 shallow water source | Code of water supply sequence number |
| sup_Shal3 | Shaping | Water withdrawal sequence number of No. 3 shallow water source | Code of water supply sequence number |
| sup_Shal4 | Shaping | Water withdrawal sequence number of No. 4 shallow water source | Code of water supply sequence number |
| sup_Shal5 | Shaping | Water withdrawal sequence number of No. 5 shallow water source | Code of water supply sequence number |
| sup_Deep1 | Shaping | Water withdrawal sequence number of No. 1 deep water source | Code of water supply sequence number |
| sup_Deep2 | Shaping | Water withdrawal sequence number of No. 2 deep water source | Code of water supply sequence number |
| sup_Deep3 | Shaping | Water withdrawal sequence number of No. 3 deep water source | Code of water supply sequence number |
| sup_Deep4 | Shaping | Water withdrawal sequence number of No. 4 deep water source | Code of water supply sequence number |
| sup_Deep5 | Shaping | Water withdrawal sequence number of No. 5 deep water source | Code of water supply sequence number |
| sup_Out1 | Shaping | Water withdrawal sequence number of No. 1 pit-pond water source | Code of water supply sequence number |
| sup_Out2 | Shaping | Water withdrawal sequence number of No. 2 pit-pond water source | Code of water supply sequence number |
| sup_Out3 | Shaping | Water withdrawal sequence number of No. 3 pit-pond water source | Code of water supply sequence number |
| sup_Out4 | Shaping | Water withdrawal sequence number of No. 4 pit-pond water source | Code of water supply sequence number |
| sup_Out5 | Shaping | Water withdrawal sequence number of No. 5 pit-pond water source | Code of water supply sequence number |
| sup_Pnd1 | Shaping | Water withdrawal sequence number of No. 1 external-basin water source | Code of water supply sequence number |
| sup_Pnd2 | Shaping | Water withdrawal sequence number of No. 2 external-basin water source | Code of water supply sequence number |
| sup_Pnd3 | Shaping | Water withdrawal sequence number of No. 3 external-basin water source | Code of water supply sequence number |
| sup_Pnd4 | Shaping | Water withdrawal sequence number of No. 4 external-basin water source | Code of water supply sequence number |
| sup_Pnd5 | Shaping | Water withdrawal sequence number of No. 5 external-basin water source | Code of water supply sequence number |

If there is no water supply in Table 4, the code is represented by 0.

TABLE 5

| Parameter name | Data type | Note | Content |
|---|---|---|---|
| irrID | Shaping | Code of irrigation area | Sequence number of irrigation area |
| irr_Riv1 | Shaping | Water withdrawal sequence number of No. 1 urban river water source | Code of water supply sequence number |
| irr_Riv2 | Shaping | Water withdrawal sequence number of No. 2 urban river water source | Code of water supply sequence number |
| irr_Riv3 | Shaping | Water withdrawal sequence number of No. 3 urban river water source | Code of water supply sequence number |
| irr_Riv4 | Shaping | Water withdrawal sequence number of No. 4 urban river water source | Code of water supply sequence number |
| irr_Riv5 | Shaping | Water withdrawal sequence number of No. 5 urban river water source | Code of water supply sequence number |
| irr_Res1 | Shaping | water withdrawal sequence number of No. 1 reservoir water source | Code of water supply sequence number |
| irr_Res2 | Shaping | water withdrawal sequence number of No. 2 reservoir water source | Code of water supply sequence number |
| irr_Res3 | Shaping | water withdrawal sequence number of No. 3 reservoir water source | Code of water supply sequence number |
| irr_Res4 | Shaping | water withdrawal sequence number of No. 4 reservoir water source | Code of water supply sequence number |
| irr_Res5 | Shaping | water withdrawal sequence number of No. 5 reservoir water source | Code of water supply sequence number |
| irr_Shal1 | Shaping | water withdrawal sequence number of No. 1 shallow water source | Code of water supply sequence number |
| irr_Shal2 | Shaping | water withdrawal sequence number of No. 2 shallow water source | Code of water supply sequence number |
| irr_Shal3 | Shaping | water withdrawal sequence number of No. 3 shallow water source | Code of water supply sequence number |
| irr_Shal4 | Shaping | water withdrawal sequence number of No. 4 shallow water source | Code of water supply sequence number |
| irr_Shal5 | Shaping | water withdrawal sequence number of No. 5 shallow water source | Code of water supply sequence number |
| irr_Deep1 | Shaping | water withdrawal sequence number of No. 1 deep water source | Code of water supply sequence number |
| irr_Deep2 | Shaping | water withdrawal sequence number of No. 2 deep water source | Code of water supply sequence number |
| irr_Deep3 | Shaping | water withdrawal sequence number of No. 3 deep water source | Code of water supply sequence number |
| irr_Deep4 | Shaping | water withdrawal sequence number of No. 4 deep water source | Code of water supply sequence number |
| irr_Deep5 | Shaping | water withdrawal sequence number of No. 5 deep water source | Code of water supply sequence number |
| irr_Out1 | Shaping | water withdrawal sequence number of No. 1 pit-pond water source | Code of water supply sequence number |
| irr_Out2 | Shaping | water withdrawal sequence number of No. 2 pit-pond water source | Code of water supply sequence number |
| irr_Out3 | Shaping | water withdrawal sequence number of No. 3 pit-pond water source | Code of water supply sequence number |
| irr_Out4 | Shaping | water withdrawal sequence number of No. 4 pit-pond water source | Code of water supply sequence number |
| irr_Out5 | Shaping | water withdrawal sequence number of No. 5 pit-pond water source | Code of water supply sequence number |
| irr_Pnt1 | Shaping | water withdrawal sequence number of No. 1 external-basin water source | Code of water supply sequence number |
| irr_Pnt2 | Shaping | water withdrawal sequence number of No. 2 external-basin water source | Code of water supply sequence number |
| irr_Pnt3 | Shaping | water withdrawal sequence number of No. 3 external-basin water source | Code of water supply sequence number |
| irr_Pnt4 | Shaping | water withdrawal sequence number of No. 4 external-basin water source | Code of water supply sequence number |
| irr_Pnt5 | Shaping | water withdrawal sequence number of No. 5 external-basin water source | Code of water supply sequence number |

If there is no water supply in Table 5, the code is represented by 0.

TABLE 6

| | | | |
|---|---|---|---|
| Parameter name | Data type | Note | Content |
| Cnty_surf(1,1) | Example | Surface water withdrawal of No. 1 administrative region in the 1st year | Water withdrawal |
| Cnty_surf(1,2) | Example | Surface water withdrawal of No. 1 administrative region in the 2nd year | Water withdrawal |
| : | : | : | : |
| Cnty _surf(M,N) | Example | Surface water withdrawal of No. M administrative region in Nth year | Water withdrawal |
| Cnty_gw(1,1) | Example | Groundwater withdrawal of No. 1 administrative region in 1st year | Water withdrawal |
| Cnty_gw(1,2) | Example | Groundwater withdrawal of No. 1 administrative region in the 2nd year | Water withdrawal |
| Cnty_gw(M,N) | Example | Groundwater withdrawal of No. M administrative region in Nth year | Water withdrawal |

TABLE 7

| Parameter name | Way of parameter adjustment | Physical significance | Parameter adjustment value |
|---|---|---|---|
| CN2 | r | Initial SCS Runoff Curve Number under humid condition II | 1.37 |
| GWQMN | v | Threshold depth of “base flow” produced by shallow aquifer | 1098 |
| GW DELAY | v | Groundwater recharge delay coefficient | 10.4 |
| ALPHA BF | v | Baseflow alpha factor | 0.38 |
| ESCO | v | Soil evaporation compensation coefficient | 0.49 |
| EPCO | v | Plant absorption compensation factor | 0.29 |
| GW_REVAP | v | Shallow groundwater reevaporation coefficient | 0.10 |
| REVAPMN | v | Shallow groundwater reevaporation threshold | 522 |
| α | v | Evaporation ratio of channel system water loss | 0.09 |
| SOL K | r | Saturated hydraulic conductivity in soil | 0.52 |
| RCHRG DP | v | Permeability ratio of deep aquifer | 0.15 |
| β | v | Infiltration ratio of channel system water loss | 0.50 |
| SOL AWC | r | Available soil moisture | 1.11 |
| pip | v | Leakage rate of pipe network | 0.10 |
| φ | v | Effective utilization coefficient of channel system water | 0.56~0.69 |
| ω | v | Effective utilization coefficient of field water | 0.95 |
| r | v | Water consumption rate of residential and industrial land | 0.2~0.45 |
| v | v | Sewage disposal rate | 1.0 |
| re | v | Reclaimed water utilization rate | 0 |

In Table 7, v indicates that the parameter adjustment value replaces the original parameter value; and r indicates that the original parameter value is multiplied by the parameter adjustment value.

TABLE 8

| Hydrological station | R² | | Eₙₛ | |
|---|---|---|---|---|
| | Calibration period | Validation period | Calibration period | Validation period |
| Xindianpu | 0.792 | 0.643 | 0.756 | 0.635 |

TABLE 9

| Region | Water consumption | | | | Water supply | |
|---|---|---|---|---|---|---|
| | Domestic water | Industrial water | Agricultural water | Total water consumption | Surface water supply | Groundwater supply |
| Wolong District | 0.54% | 0.72% | 3.41% | 1.62% | 0.01% | 1.57% |
| Wancheng District | -0.04% | -0.02% | 1.15% | 0.59% | 0 | 1.01% |
| Zhenping County | 0.01% | 0 | 0 | 0 | 0.01% | 0 |

Based on the SWAT model, the present disclosure develops a distributed natural-artificial hydrological model cycle. The distributed natural-artificial hydrological cycle model is endowed with the functions of simulating dynamic reciprocation between natural-artificial hydrological cycles, and integrating development, utilization and regulation of water resources, thereby simulating the process of natural-artificial hydrological cycles of a basin based on modes of urban multi-source water supply and multi-source irrigation water supply. During the running of the model, the dynamic reciprocation between natural hydrological cycle and artificial hydrological cycle can be maintained all the time. In this way, not only the influence of the hydrological cycle on artificial water withdrawal and use is reflected, but also the real-time intervention effect on development, utilization and regulation of water resources on the hydrological cycle is reflected. Thus, it provides a scientific reference basis for in-depth understanding of the hydrological cycle mechanism of a basin under the influence of high-intensity human activities, as well as rational development and utilization of water resources.

The above described are merely specific implementations of the present disclosure, and the protection scope of the present disclosure is not limited thereto. Any modification or replacement easily conceived by those skilled in the art within the technical scope of the present disclosure should fall within the protection scope of the present disclosure. Therefore, the protection scope of the present disclosure should be subject to the protection scope of the claims.

1. A design method for a distributed hydrological cycle model based on a multi-source complementary water supply mode, comprising the following steps:
Step S1: conducting hydrological response unit (HRU) division by adopting a nested slope discretization method based on attributes of “basin, water resources region, administrative region, irrigation area, land use, soil, slope”, wherein HRUs obtained after division each have corresponding attributes;
Step S2: constructing an HRU attribute recognition module, wherein the HRU attribute recognition module is configured to recognize attributes of an HRU;
Step S3: designing a multi-source complementary water supply module, wherein the multi-source complementary water supply module is configured to invoke the HRU attribute recognition module to recognize the attributes of each HRU, determining a land use type, a corresponding water source and a water supply priority of the water source according to the recognized attributes, and invoking, by the water supply priority of the water source, a corresponding water source module to conduct water withdrawal; and
Step S4: connecting the multi-source complementary water supply module with modules modified in a Soil and Water Assessment Tool (SWAT) model to realize real-time data exchange, wherein the HRU allocates and regulates water resources according to input information about water demand, types of water sources, rules of water supply priority, and water conservancy projects, and information about natural hydrological conditions which is provided by the SWAT model, and outputs and transfers information about an artificial hydrological cycle regarding daily “water supply, water use, water consumption, water drainage” to the SWAT model, wherein step S3 specifically comprises:
designing a water source code information file, wherein the water source code information file is configured to read designated water source information, six types of water sources are set and comprise transferred water, reservoir water, urban river water, shallow groundwater, deep groundwater and pit-pond water, and the water source code information file is read by program instructions;
designing a water supply priority information file, wherein the water supply priority information file is configured to read information about water supply priority, and specify a water supply priority of a water source, and is read by program instructions;
designing a water withdrawal control information file, wherein the water withdrawal control information file is configured to read information about water supply control volume, and recognize an annual surface water supply control volume and an annual groundwater exploitation control volume of an administrative region to which the HRU belongs for the subsequent calculation of water withdrawal volume of water sources; and
designing a calculation process for multi-source complementary water supply, wherein the specific calculation process is as follows:
first, recognizing the land use type of the HRU, wherein if it is construction land, a program enters a calculation process for urban and rural water supply; if it is agricultural land, the program enters a calculation process for irrigation water; and if it is other land use type, the program ends;
invoking a corresponding water source module by recognizing a water withdrawal source identification code of the HRU, recognizing the number, type and water withdrawal sequence of water sources of each HRU by reading the water source code information file and water supply priority information file, and invoking each water source module in turn according to the water withdrawal source identification code; and
seeking water sources and conducting water withdrawal from each water source according to a water supply sequence of the HRU until the HRU’s daily demand for domestic water, industrial water, and agricultural irrigation water is satisfied, or until the last water source finishes water supply; and
the calculation for multi-source complementary water supply comprises the following steps:
specifying a daily water demand WD set by a target HRU;
specifying the number k, water source codes and water supply priority of water sources of the target HRU, wherein k≤30;
invoking the water source modules in sequence to calculate a water withdrawal volume of a water source, wherein the water source modules comprise a rchuse module, a res module, watuse module, an irr rch module, an irr res module and an irrsub module, the water withdrawal volume of the water source depends on a daily water demand of the HRU and an available water supply of the water source, while the available water supply depends on an accessible water volume of the water source, the water supply capacity of a water withdrawal project and the water withdrawal control volume, wherein the calculation formulas are as follows:
$$W S {P}_{i j} = m i n \left(W {D}_{i} - {\sum }_{k = 1}^{j - 1} W S {P}_{k} , W s {c}_{i j}\right)$$
$$W s {c}_{i j} = m i n \left(W {A}_{i j} , W {F}_{i} , W M {X}_{i j} - {\sum }_{k = 1}^{j - 1} W S {P}_{k}\right)$$
$$W M {X}_{i j} = \left\{\begin{matrix}m i n \left(W U M - {\sum }_{m = 1}^{i - 1} {\sum }_{k = 1}^{j} W S {P}_{k} , W S M - {\sum }_{m = 1}^{i - 1} {\sum }_{k = 1}^{j} W S {P}_{k}\right) \\ m i n \left(W U M - {\sum }_{m = 1}^{i - 1} {\sum }_{k = 1}^{j} W S {P}_{k} , W G M - {\sum }_{m = 1}^{i - 1} {\sum }_{k = 1}^{j} W S {P}_{k}\right)\end{matrix}\right)$$
wherein, i denotes a sequence number of an HRU; j denotes a water supply priority number of a water source; WSP denotes an actual daily water withdrawal (m³) of a water source; WD indicates a daily water demand (m³) of an HRU; Wsc indicates a daily available water supply (m³) of a water source; WF indicates the water supply capacity (m³) of a water withdrawal project; WA indicates a daily accessible water volume of a water source (m³) ; WMX denotes an annual water withdrawal control volume (m³) , and WUM denotes an annual water consumption control volume (m³) ; WSM denotes an annual surface water withdrawal control volume (m³) ; and WGM denotes an annual groundwater exploitation control volume (m³) ; wherein
for a water source with a water supply priority of 1, priority is given to water withdrawal from the water source; if the available water supply of the water source is Wsc₁>WD, then the water supply of the water source is WSP₁=WD, a water supply program ends, and the total water supply of the water source of the HRU is WSP= WSP₁; otherwise, WSP₁=Wsc₁, and the water demand of the HRU changes to Wf =WD-Wsc₁, and the program will continue to seek the next grade of water source;
for a water source with a water supply priority of j, j=2, ..., k-1; k≤30, if the daily available water supply of the water source is Wscⱼ>Wf, then the water supply of the water source is WSPⱼ=Wf, the programends, and the total water supply of the water source the HRU is SP=WSP+WSPⱼ; otherwise, WSPⱼ=Wscⱼ, the water demand of the HRU changes to Wf=Wf-Wscⱼ, and the program will continue to seek the next grade of water source; and
for a water source with a water supply priority of k, k≤30, if the daily available water supply of the water source is Wscₖ>Wf, then the water supply of the water source is WSPₖ=Wf, the program ends, and the total water supply of the HRU is WSP=ΣWSPᵢ; otherwise, WSPₖ=Wscₖ, the water demand of the HRU changes to Wf=Wf-Wscₖ, and the program ends.

2. The design method for a distributed hydrological cycle model based on a multi-source complementary water supply mode according to claim 1, wherein step S1 comprises:
extracting a river network of a basin from a DEM using ArcGIS to conduct division to obtain natural sub-basins;
superimposing land use information, soil type information and slope information on the natural sub-basins to conduct division to obtain natural HRUs;
setting boundaries of an administrative region and a water resources region for the natural HRU to further divide the natural HRUs; and
superimposing irrigation areas with the natural HRUs according to the distribution of the irrigation areas to finally complete HRU division, wherein each HRU has a sub-basin attribute, a water resources region attribute, an administrative region attribute, an irrigation area attribute, a land use type attribute and a soil type attribute.

3. The design method for a distributed hydrological cycle model based on a multi-source complementary water supply mode according to claim 2, wherein step S2 comprises:
constructing the HRU attribute recognition module which is configured to read specified HRU attributes, wherein the specified HRU attributes comprise a sub-basin attribute, a water resources region attribute, an administrative region attribute, and an irrigation area attribute; and
putting the constructed HRU attribute recognition module in a main module in the SWAT model to facilitate invocation of the HRU attribute recognition module.

4-5. (canceled)

6. The design method for a distributed hydrological cycle model based on a multi-source complementary water supply mode according to claim 1, wherein modification for the relevant modules in the SWAT model in step S4 specifically comprises:
shielding the rchuse module, the res module, the watuse module, the irr_rch module, the irr_res module and the irrsub module, and forgoing adopting a single water source withdrawal mode; and putting the foregoing modules into the multi-source complementary water supply module for invoking;
adding relevant codes, and replacing parameters waterrch and wuresn in the rchuse module and the res module with parameter WSPᵢ, respectively to achieve connection of the multi-source complementary water supply module Multi_sc with the rchuse module and the res module as well as invoking, wherein i =1,2;
modifying relevant programs to add functions of transferred water withdrawal and transferred water volume restriction so as to control water supply within a total transferred water limit, wherein a calculation formula is expressed as follows:
$${\sum }_{i} {\sum }_{j} \text{waterout} \left(i , j\right) \leq M X 5$$
wherein waterout (i,j) denotes transferred water consumption (m³) of the jth HRU on the ith day; and WX5 denotes total transferred water limit (m³) ;
adding codes in the watuse module, and replacing parameters watershal, waterdeep, waterout, and waterpnd in the watuse module with parameter WSPᵢ, respectively to achieve connection of the multi-source complementary water supply module Multi_sc with the watuse module as well as invoking, wherein i=3,4,5,6;
adding a calculation program of the following formula in the rchuse module, the res module, and the watuse module:
$$\text{WSP} = \text{WSP} ⋅ \left(1 - p i p\right)$$
wherein, pip denotes a leakage rate of water supply pipe network;
adding a pit-pond irrigation function, completing a transferred water irrigation function, and imposing water supply restriction to control an irrigation water withdrawal within the total transferred water limit:
$${\sum }_{i} {\sum }_{j} \text{wirrout} \left(i , j\right) \leq M X 5$$
$${\sum }_{i} {\sum }_{j} w i r r p n t \left(i , j\right) \leq M X 6$$
wherein, wirrout (i,j) denotes transferred water irrigation consumption (m³) of the jth HRU on the ith day; WX5 denotes total transferred water limit (m³) , and wirrpnt (i,j) denotes pit-pond irrigation consumption (m³) of the jth HRU on the ith day; and WX6 denotes pit-pond available water supply (m³) ;
modifying source codes of the irr_rch module, the irr_res module, and the irrsub module to add simulation on a channel system delivery process comprising channel water loss and channel recession, wherein the channel water loss comprises two parts of channel water evaporation loss and channel leakage loss, and the main calculation formulas are as follows:
$$E {T}_{c a n} = I R {R}_{c a n} ⋅ \left(1 - φ\right) ⋅ α$$
$$L {s}_{c a n} = I R {R}_{c a n} ⋅ \left(1 - φ\right) ⋅ β$$
$$S u r {p}_{c a n} = I R {R}_{c a n} ⋅ \left(1 - φ\right) ⋅ \left(1 - α - β\right)$$
wherein, ET_{can} denotes a channel system evaporation loss (mm); IRR_{can} denotes an irrigation water volume (mm) entering a channel; Ls_{can} denotes a channel system leakage loss (mm) ; Surp_{can} denotes a channel system recession volume (mm); φ denotes an effective utilization coefficient of channel system water; α denotes a channel system evaporation coefficient; and β denotes a channel system leakage coefficient;
adding a calculation program for leakage loss by modifying relevant codes of a percmain module, wherein a calculation formula is as follows:
$$W s {l}_{y r 1 , t} = W s {l}_{y r 1 , t - 1} + i n {f}_{p c p} + i n {f}_{i r r} + i n {f}_{w e t} + L {s}_{c a n}$$
wherein, ^{Wsl}yr1,t+1 denotes soil water content (mm) of a first layer of soil on the t-th day; ^{Wsl}yr1,t denotes soil water content (mm) of a first layer of soil on the (t-1) th day; inf_{pcp} denotes precipitation infiltration capacity (mm); infᵢᵣᵣ denotes irrigation infiltration capacity (mm); and inf_{wet} denotes lake and reservoir wetland infiltration capacity (mm);
modifying groundwater recharge codes in a gwmod module to achieve simulation on water leakage of a pipe network, wherein a calculation formula is as follows:
$$\begin{matrix}r {h}_{ε} = \left(1 - exp \left(- 1 / G W \_ D E L A Y\right)\right) ⋅ \left(p r c + W S P ⋅ p i p / A r e a\right) \\ + exp \left(- 1 / G W \_ D E L A Y\right) ⋅ r {h}_{L - 1}\end{matrix}$$
wherein, ^{rh}t denotes groundwater recharge capacity (mm) on the t-th day; ^{rh}t-1 denotes groundwater recharge capacity (mm) on the (t-1) th day; prc denotes soil water leakage (mm) of recharged groundwater; GW_DELAY denotes groundwater recharge delay coefficient (mm) ; and Area denotes the area (m²) of an HRU;
adding the multi-source complementary water supply module in a subbasin module, and conducting in-year dynamic complementary water supply operation on water sources by reading specified type, number, water source codes, water withdrawal volume, and water withdrawal time of water sources to achieve multi-source combined water supply simulation during the running of the SWAT model;
superimposing channel system recession with earth surface runoff by modifying relevant codes of a surface module to participate in calculation of flow concentration of river channels, wherein a calculation formula is as follows:
$$s u r {f}_{t} = s u r {f}_{0} + S u r {p}_{c a n}$$
wherein, ^{surf}t denotes runoff (mm) after channel recession; and ^{surf}0 denotes runoff (mm) before channel recession;
wherein a point source module comprises a recday module and a recmon module, wherein relevant codes are modified in the recday module and the recmon module, a pollution discharge parameter WDR is used to replace parameters floday and flomon, respectively, and the calculation formulas are as follows:
$$\text{WP} \text{=} \text{WSP} ⋅ \left(1 - \text{r}\right)$$
$$\text{WDR} \text{=} \text{WP} ⋅ \left(1 - v\right) + \text{WP} ⋅ \text{v} ⋅ \left(1 - r e\right)$$
wherein WDR denotes urban sewage output (m³) ; WP denotes sewage discharge (m³) ; r denotes a water consumption rate; v denotes a sewage disposal rate of a sewage disposal plant; and re denotes a reclaimed water utilization rate; and
putting the constructed HRU attribute recognition module in the main module in the SWAT model to facilitate invocation of the HRU attribute recognition module.
